(19) United States
(12) Patent Application Publication
(10) Pub. No.: US 2006/0176879 A1
(43) Pub. Date: Aug. 10, 2006

(54) Method of constructing a unique transmission address by a server and server using this method

(76) Inventors: Jean-Francois Fleury, Riantec (FR); Mary-Luc Champel, Marpire (FR)

Correspondence Address: THOMSON LICENSING INC., PATENT OPERATIONS, PO BOX 5312, PRINCETON, NJ, 08543-5312, US

(21) Appl. No.: 11/327,699

(22) Filed: Jan. 6, 2006

(30) Foreign Application Priority Data
Jan. 10, 2005 (FR) 05/50079

(51) Int. Cl. H04L 12/56; G06F 15/16; H04J 3/26

(52) U.S. Cl. 370/390; 370/432; 709/245

(57) ABSTRACT

The method can be used to provide a solution to the allocation of multicast addresses within a local area network by stream servers, particularly audio/video. This solution does not involve configuration or particular servers. The invention relies on the use of identifiers of the transmitted stream to construct the multicast address. Also, this method enables the transmission client to know the duly constructed multicast address to subscribe to a stream.

### FIELD OF INVENTION

The present invention relates to the field of digital data stream. transmission on an IP network and, more particularly, the way in which an audio/video stream server will choose unique multicast addresses on the network.

### BACKGROUND OF THE INVENTION

On IP networks, there are various ways of transmitting data to a number of users. The means most commonly used in the context of the transmission of digital services, for example audiovisual, is a so-called multicast mode. In this mode, a server will send the data packets corresponding to the service to a “virtual” address called a multicast address. This address is virtual in that it does not correspond to the IP address of a destination machine of the data packets. In practice, a machine wishing to receive the stream of data sent will subscribe to the multicast. To do this, it will use the IGMP protocol (“Internet Group Management Protocol”). It will send a “join” command with the multicast address, this command will be transmitted from router to router within the network until it reaches a router already relaying this stream or directly connected to the server. Once the source, or a point of the transmission is reached, the intermediate routers between this point and the machine wishing to receive the stream will be configured to transmit this stream from the server to the destination machine

It can therefore be seen that this multicast protocol uses addresses that are virtual inasmuch as they do not represent physical machines. An address space is thus reserved for this purpose, comprising the addresses from 224.0.0.0 to 239.255.255.255. These addresses correspond to the addresses for which the first 4 bits are “1110”.

A working group (“Multicast Address Allocation”) of the IETF (“Internet Engineering Task Force”) is working on resolving the problem of allocating multicast addresses. In practice, the servers wishing to transmit data streams must choose an address and a port for this transmission. This address must be located in the space reserved for this purpose and must not collide with another address that would be chosen by another server. The IETF proposal is based on one or more multicast address allocation servers. A stream server requiring an address for a new transmission will therefore contact one of these address servers to obtain this address. The management of the pool of reserved addresses and any coordination between servers are also managed.

This proposal, although quite functional, is relatively clumsy to implement. In the context of local area networks, home networks for example, local servers will distribute audio/video streams over IP. These streams are normally obtained from satellite or cable transmission and are retransmitted either directly or after storage. When such a device needs to transmit an audio/video stream, it must choose a multicast address to use for this transmission. It would be sensible to be able to put in place a less clumsy multicast address allocation or construction mechanism requiring neither hardware nor particular configuration, but ensuring the uniqueness within the local area network of the duly constructed addresses. Also, the clients need to know these addresses.

### SUMMARY OF THE INVENTION

The invention provides a solution to the allocation of multicast addresses within a local area network by stream servers, in particular audio/video. This solution involves neither configuration nor particular servers. The invention relies on the use of identifiers of the transmitted stream for constructing the multicast address. Also, this method enables the transmission client to know the duly constructed multicast address to subscribe to a stream.

The invention relates to a method of construction, by a data stream server for a communication network, of a multicast address and/or the associated port number for the transmission of a data stream. This method includes at least the following step:
determination of at least a part of the multicast address and/or the associated port number according to at least one identifier of the data to be transmitted to this address.

According to a particular embodiment of the invention, the determination step uses all or part of at least one identifier of the stream to determine the bits of the multicast address and/or the constructed associated port number.

According to a particular embodiment of the invention, the network being an IP local area network running at IP version 6, the determination step uses the at least one identifier of the stream for determining the bits of the group identifier of the constructed multicast address.

According to a particular embodiment of the invention, the identifier is the unique identifier of the stream in the network.

The invention also relates to a data stream server in multicast mode within a communication network having:
means of connection to the network;
means of transmitting data streams in multicast mode on this IP local area network;
means of constructing a multicast address and/or the associated port number according to at least one identifier of the data to be transmitted.

### LIST OF FIGURES

The invention will be better understood, and other features and advantages will become apparent from reading the description that follows, the description referring to the appended drawings, in which:

FIG. 1 represents the address spaces recommended for private networks.

FIG. 2 represents the structure of an IPV6 (IP version 6) multicast address.

FIG. 3 represents examples of multicast address construction according to construction schemes according to the invention.

FIG. 4 represents an example of architecture for a server according to the exemplary embodiment of the invention.

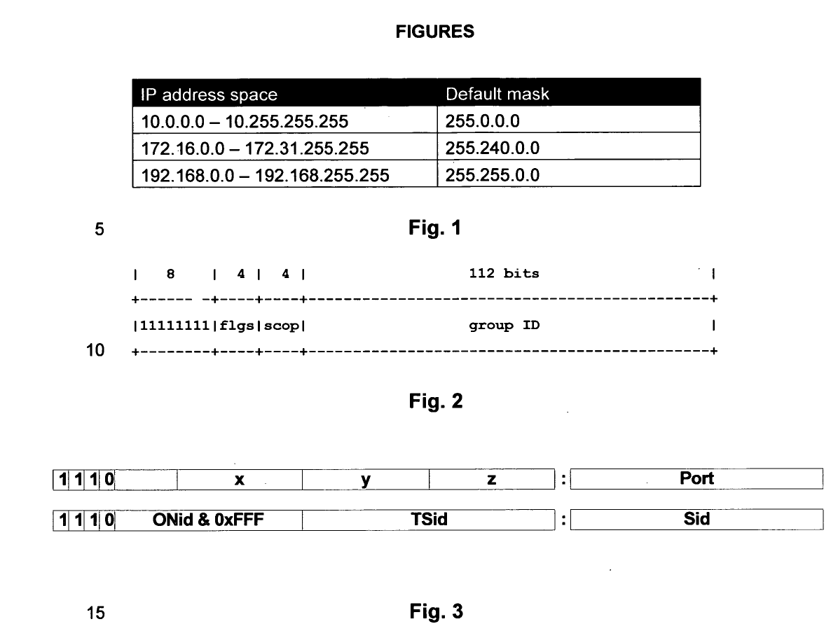

### DETAILED DESCRIPTION OF THE INVENTION

On packet data networks, such as, for example, the Internet, IP local area networks or others, there are various ways of transferring information. These ways can be classified in three categories according to the number of senders and receivers involved in this transmission. First, there is unicast transmission, whereby a sender can send an information packet to a single receiver identified by its address in the network. This is the transmission mode used by the most popular protocols of the Internet such as the HTTP (Hyper Text Transfer Protocol) protocol for transferring web pages or the file transfer protocol FTP. Another transmission mode consists, for a sender, in transmitting a packet in broadcast mode. In this mode, the packet sent by the sender is sent to all the nodes of the network. This mode is not available on the Internet but is found on local area networks. The third mode consists, for a sender or a group of senders, in transmitting a packet to a group of receivers, in a multicast mode. In this mode, the packets are sent to a so-called multicast address and will be routed to all the recipients belonging to the transmission group. A client who joins a transmission group is said to subscribe to the group and a client who leaves the group is said to unsubscribe from the group.

The multicast mode is used in practice to save on intermediate bandwidth in the network when a source is sending data to a group of recipients. In practice, in this case, the use of a unicast mode requires the data to be sent as many times as there are recipients. This mode involves duplicating packets on parts of the network common to the paths between the source and the various recipients. On the other hand, the multicast enables the data to be sent only once, this data being duplicated on the routers of the network, according to the paths leading to the recipients belonging to the transmission group.

Within a local area network, for example a home network, it is increasingly commonplace to have servers for audiovisual or other content transmitted in data stream form. These streams are normally transmitted in multicast mode because this saves on bandwidth when the transmission is to a number of clients. This may apply in the home, for example for transmitting music to a number of rooms or enabling several members of the family to follow one and the same content in different rooms. Also worthy of mention is the combined recording and displaying of media. In all these uses, there are a number of clients, in the sense of devices receiving a content, within the home and therefore on the local area network.

On this local area network, a certain number of devices will therefore act as audio/video stream servers, preferably in multicast mode. Typical of these are digital video recorders, gateways receiving content by satellite or cable and distributing it over the home network, or any other device acting as a source of content on the local area network. All these devices will therefore, whenever they want to transmit content, need to choose a multicast address and port pairing. It is essential to ensure the uniqueness of this pairing so as to avoid collisions between different transmissions by devices on the local area network. A client wanting to connect to the transmission must know this address.

Non-collision with the multicast addresses of streams originating from a network external to the local area network but accessible to the clients of the local area network is not guaranteed by this mechanism. It may be a home network connected to an external media distribution network. A way of ensuring this non-collision is to implement an address translation in the gateway connecting the local area network and the distribution network. Since the gateway is an element of the local area network, the latter can adopt the rules described in the document for transmitting the streams that it receives from the external network and to clients internal to the local area network.

To avoid having to put in place and configure multicast address servers, this document proposes to use the characteristics of the stream to be transmitted to construct the multicast address and/or the port used for the stream transmission. In practice, the audio/video streams are normally identified uniquely. It is therefore possible to construct unique addresses and/or port numbers based on the stream identifiers. In this way, the uniqueness of the duly constructed addresses is ensured within the network and, on the other hand, a client using the same method will be able to construct the transmission address of a stream to which he wants to subscribe.

In RFC 2365, the IANA defined a multicast address space for private networks between 239.255.0.0 and 239.255.255.255. Because of this, the first 16 bits of the multicast addresses are fixed at 239.255. However, here too, failure to observe this recommendation, so long as there is no attempt to depart from the general multicast address space (224.0.0.0 to 239.255.255.255), will not cause any operating problems.

The IPV6 multicast addresses are defined in RFC 2373. FIG. 2 describes the format of these addresses: a first field of eight 1 bits, a 4-bit “flgs” field, a 4-bit “scop” field followed by a 112-bit group identifier. In a local area network, the “flgs” value must be 1 whereas the “scop” value must be 2, indicating that the address is temporary and limited to the link.

It is worth noting that, in the IPV6 case, there can be no confusion between the multicast addresses external to the local area network and those that are defined on this network. In practice, the “flgs” and “scope” fields of these addresses will be different.

The exemplary embodiment of the invention is situated in the context of the transmission of audio/video streams in DVB (Digital Video Broadcast) format. This standard defines a set of three identifiers of the stream known as the DVB triplet. A definition of this triplet can be found in the document: “Digital Video Broadcasting (DVB); Specification for Service Information (SI) in DVB systems; EN 300 468 v1.3.1)”. This triplet comprises a network identifier (ONid, for Original Network ID) present in the NIT (Network Information Table), encoded on 16 bits, a transport stream identifier (TSid) present in the SDT (Stream Description Table) encoded on 16 bits and a service identifier (Sid) also coded on 16 bits. This triplet is used to uniquely identify a service transmitted on a DVB network. In practice, the network is defined as a collection of MPEG-2 transport stream multiplexes transmitted by one and the same distribution system uniquely identified by its ONid. The transport stream is defined as the basic DVB structure for transporting services identified uniquely by the TSid within the network. The service is a sequence of programs under the control of a broadcaster and suitable for transmission within a programming identified uniquely by its Sid within the transport stream.

When a DVB stream needs to be distributed over an IP network by a server, the latter must obtain a multicast address for this distribution. This address must be unique on the local area network, with different servers needing to safeguard against the risk of using the same address for two different streams. Because of the definition of the identifiers of the stream described previously, these identifiers uniquely identify the stream concerned. It is therefore possible to use this uniqueness of the identifiers to construct addresses and/or port numbers inheriting this property of uniqueness. It is therefore proposed to use these identifiers to construct the multicast address and/or the port number.

Also, since the method of constructing the multicast address and/or the port number is known, it can also be used by the client. Provided that the latter knows the stream that he wants to receive and therefore the identifiers concerned, he can apply the method to determine the transmission address to which he needs to subscribe to receive this stream.

In IPV4, the format of the multicast addresses, fixing the first 4 bits at “1110”, leaves us 28 free bits to which must be added the 16 bits of the port number, giving 44 bits. The 3 identifiers define values over a set of 48 bits (3*16). It can therefore be seen that it is not possible to establish a direct correlation between the 48 bits of the identifiers and the 44 free bits that are available for the multicast address. It is possible to resolve the problem by deciding to take account only of the 12 lowest order bits of the network identifier. This presupposes that the number of DVB networks carried over the same physical networks does not exceed 4096 and that the network identifiers are incremented in steps of 1 from 0. This assumption is more than borne out in practice by the real deployments of today.

FIG. 3 proposes a correlation enabling the multicast address and port number pairing to be constructed from the DVB triplet. It proposes a direct correlation between the port number and the Sid, the 2 low order bytes of the address corresponding to the TSid whereas the 12 low order bits of the ONid are made to correspond to the 12 low order bits of the 2 high order bytes of the multicast address. Obviously this correlation is merely an example and any correlation is possible. Similarly, functions for giving the free bits of the address/port number pairing that are not a bit-for-bit correlation can be used.

In the case of an IP version 6 network, the format of the multicast addresses (FIG. 2) leaves the 112-bit group identifier field free. The same method can therefore be used as that employed for IP version 4. Here, it is possible to use complete bit-for-bit correlations between the 3 identifiers of the stream and 48 bits chosen from the 112. Similarly, it is also possible to use functions for giving the free bits of the address/port number pairing that are not a bit-for-bit correlation.

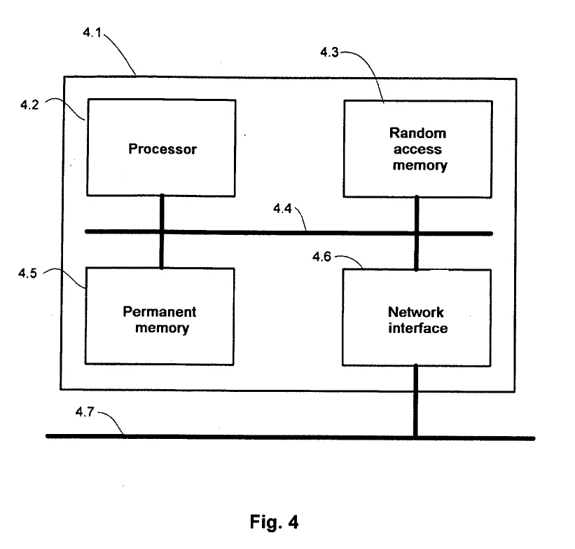

FIG. 4 represents a typical general architecture of a server, referenced 4.1, intended to implement the method. Such a device includes a network interface, referenced 4.6, intended to connect the device to the IP network referenced 4.7. It also includes a permanent memory, referenced 4.5, intended to store the programs needed to execute the method, including the stack managing IP communication, the network interface management layer and the programs managing the construction of the multicast addresses according to the method described. These programs will be loaded into the random access memory, referenced 4.3, for execution by the central processor referenced 4.2. All these elements will be interlinked via a communication bus referenced 4.4. It is obvious to a person skilled in the art that this architecture can vary in how these means are arranged and is simply an example of architecture of a server capable of implementing the method.

The method described herein directly reuses the identifiers of the stream to construct the corresponding part of the multicast address. It is obvious that any use of these identifiers in constructing the multicast address will similarly ensure the required uniqueness. As a matter of fact, the invention relies on the use of at least some of these identifiers, and their property of uniqueness, to construct unique address and port number pairings used for multicasts on the local area network without requiring the intervention of a server managing the assignment of the addresses.

1. Method of construction, by a data stream server for a communication network, of a multicast transmission address and/or the associated port number for the transmission of a data stream, wherein the method includes at least the following step:
determination of at least a part of the multicast address and/or the associated port number according to at least an identifier of the data to be transmitted to this address.

2. Method according to claim 1, wherein the determination step uses all or part of at least one identifier of the stream to determine the bits of the multicast address and/or the constructed associated port number.

3. Method according to claim 1, the network being an IP local area network running at IP version 6, wherein the determination step uses the at least one identifier of the stream for determining the bits of the group identifier of the constructed multicast address.

4. Method according to claim 1, wherein the at least one identifier is the unique identifier of the stream in the network.

5. Data stream server in multicast mode within a communication network having:
means of connection to the network;
means of transmitting data streams in multicast mode on this IP local area network;
wherein it also includes:
means of constructing a multicast address and/or the associated port number according to at least one identifier of the data to be transmitted.

6. Server according to claim 5, wherein the at least one identifier is the unique identifier of the stream in a network.
